(19) United States
(12) Patent Application Publication
(10) Pub. No.: US 2025/0088016 A1
(43) Pub. Date: Mar. 13, 2025

(54) Electronic Device Charging Stand with Adjustable Support

(71) Applicant: Kyle Hayes, Coppell, TX (US)

(72) Inventor: Kyle Hayes, Coppell, TX (US)

(21) Appl. No.: 18/367,842

(22) Filed: Sep. 13, 2023

(51) Int. Cl. H02J 7/00

(52) U.S. Cl. CPC H02J 7/0044

(57) ABSTRACT

A charging apparatus is disclosed for supporting electronic device charging. The charging apparatus includes a housing, an upper cavity, and a base. The housing having a first charging portion configured to support the surface of an electronic device. The first charging portion including a recessed charging tray and at least one opening to thread cables into the upper cavity. The upper cavity being proximate to the first charging portion. The base includes an opening to a base cavity and at least one stabilizing object. The base cavity opening is configured to receive a removeable plug.

### TECHNICAL FIELD

The present disclosure relates to electronic device stands and relates more particularly to adjustable docking stands for mobile devices.

### BACKGROUND

There are many kinds of portable electronic devices, such as smart phones, tablet computers, media players, smart watches, etc., which may come in various shapes and sizes. These devices have a wide range of capabilities. Numerous protective cases have been developed for portable electronic devices to protect such devices from scratches, shock, dirt, dust, and the like. Typically, during use they may be held in one hand while the user's other hand operates the device. Many cases and materials that electronic devices commonly rest on are made of a material that can scratch the device. However, there are situations where it is convenient to put the device down so the user has both hands free.

### SUMMARY

A charging apparatus is shown and described. The charging apparatus may include a housing having a charging portion, the charging portion having a recessed charging tray where the recessed charging tray is configured to receive a MagSafe charging device. The housing may include an opening to thread cables into a cord tunnel. The housing of the charging apparatus may include an upper cavity connected to the charging portion. The charging apparatus may also include a base having an opening to a base cavity, where the base cavity opening is configured to receive a removeable plug. The base cavity may include at least one stabilizing object that which a user may add or remove to allow for optimal support.

The nature and advantages of the present invention will be more fully appreciated after reviewing the accompanying drawings, detailed description and claims.

### BRIEF DESCRIPTION OF THE DRAWINGS

The accompanying drawings illustrate one or more preferred embodiments of the invention and together with a general description above and the detailed description below serve to explain the principles of invention. The drawings and description herein are not intended to be exhaustive nor limiting of the invention.

FIG. 1 is a front perspective view of an embodiment of a charging apparatus embodiment.

FIG. 2 is a rear perspective view of an embodiment of a charging apparatus embodiment.

FIG. 3 is a rear side perspective view of a charging apparatus embodiment.

FIG. 4 is a front side perspective view of a charging apparatus embodiment.

FIG. 5 is a different side perspective view of a charging apparatus embodiment to that shown in FIG. 3.

FIG. 6 is a front side perspective view of a charging apparatus embodiment.

FIG. 7 is a bottom perspective view of a charging apparatus embodiment.

FIG. 8 is a foreshortened bottom perspective view of a charging apparatus embodiment.

FIG. 9 is a side cut-away view of a charging apparatus embodiment.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Furthermore, the terms “comprise,” “include,” “have.” and any variations thereof, are intended to cover a non-exclusive inclusion, such that a process, method, article, or apparatus that comprises a list of elements is not necessarily limited to those elements, but may include other elements not expressly listed or inherent to such process, method, article, or apparatus.

The terms “left.” “right.” “front,” “back.” “top,” “bottom,” “over.” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical, mechanical, magnetic, or other manner.

### DETAILED DESCRIPTION

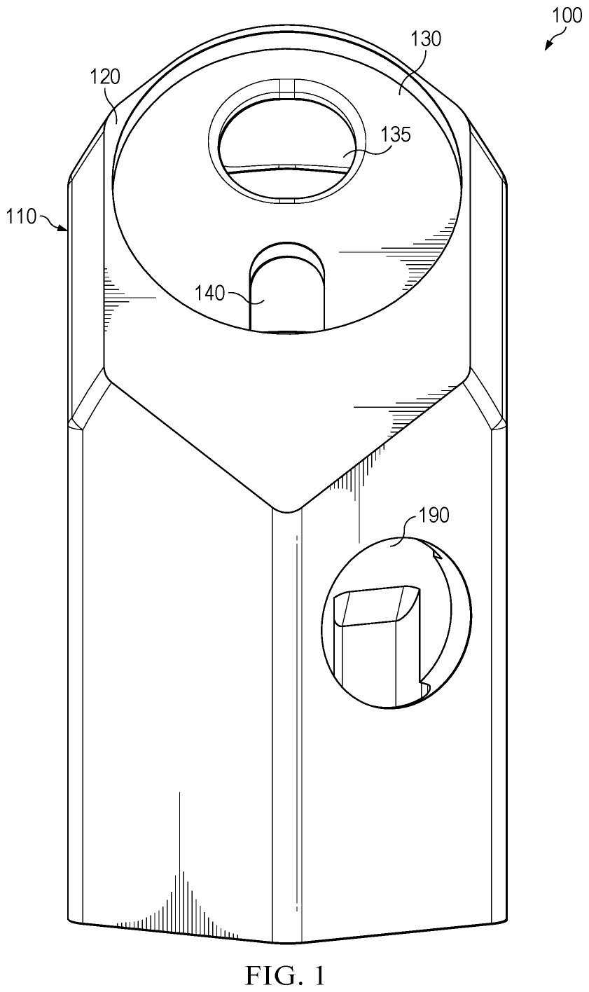

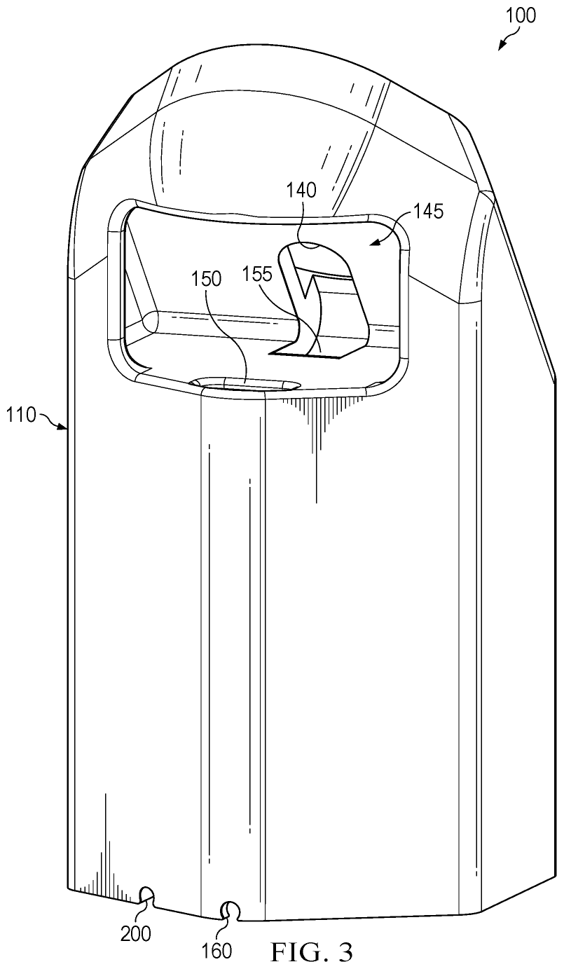

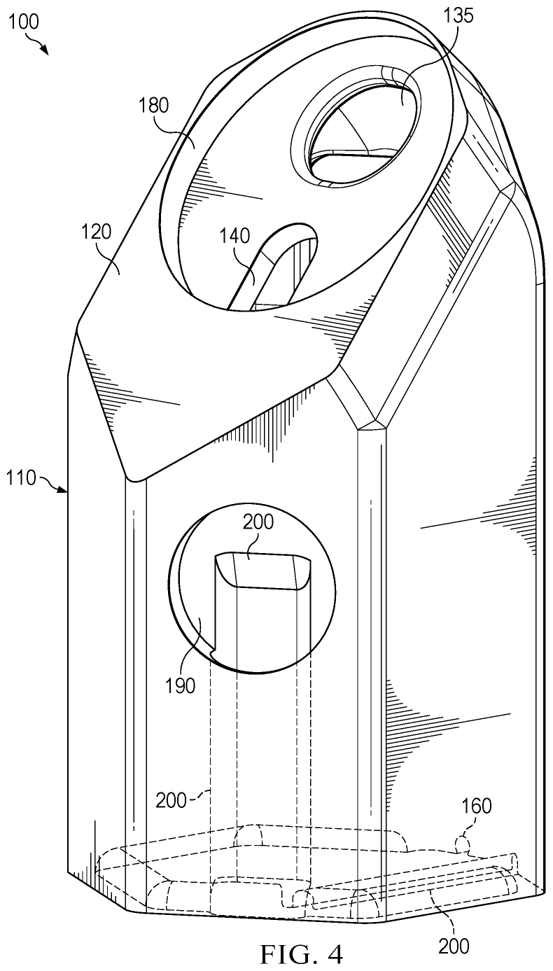

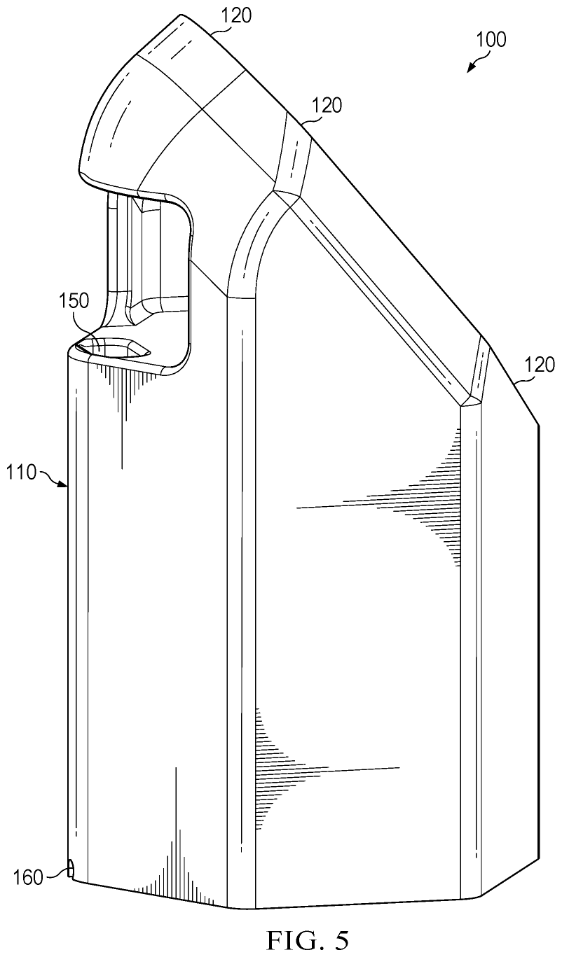

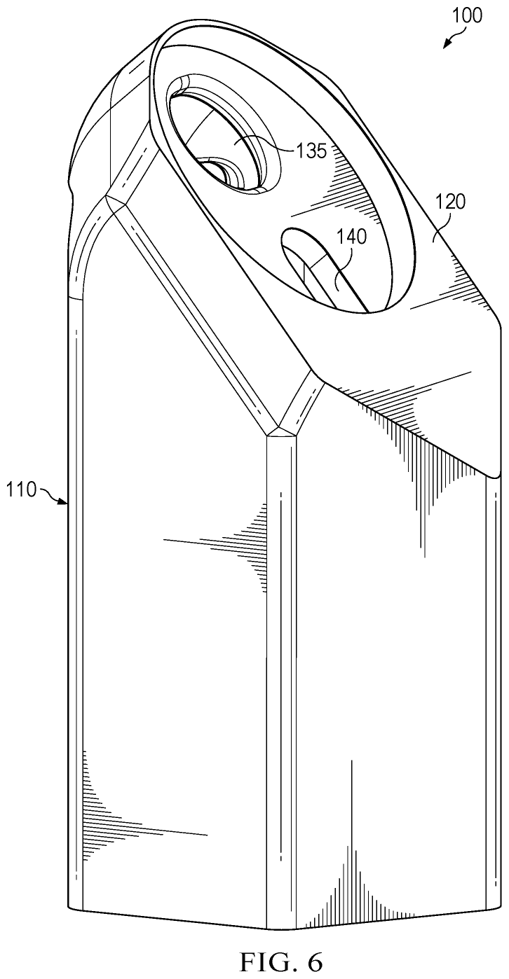

Without any intent to limit the scope of this invention, reference is now made to FIGS. 1-9 illustrating an embodiment of the charging apparatus 100 which can achieve each of the specific objectives set forth above, as well as other objectives that will become apparent from the ensuing detailed description.

The charging apparatus 100 generally comprises a housing 110 and a base 165. In some embodiments, the housing 110 is made of a rubber composite. In other embodiments, the base 165 is made of a rubber composite. In some embodiments, the housing 110 and base 165 are made of a rubber composite. In another example, housing 110 and base 165 can be metal, plastic, woods, or other suitable material. The housing 110 typically includes a charging portion 120 and an upper cavity 155. The first charging portion 120 is composed of a recessed charging tray 130 configured to allow for the reception of a MagSafe charging device in the removal access hole 135 and at least one opening 140 into an upper cavity 155. Looking at the charging apparatus 100 in FIG. 1, the primary function of the recessed charging tray 130 is to receive a charging device. In some embodiments, surfaces of the charging apparatus (such as charging portion 120) may be covered with non-scratching or non-slip materials such as leather, rubber, woven fabric, or non-woven fabric.

The MagSafe charger introduced by Apple is a wireless charging technology involving magnetism. The MagSafe charger contains a magnet that tightly attracts some electronic devices and the device is charged wirelessly. When an electronic device compatible with MagSafe charging technology is connected to a MagSafe charger, the device and charger are tightly coupled from magnetic interactions.

When the recessed charging tray 130 contains a MagSafe charging device, a user may couple an electronic device to the charging portion 120 that will then initiate the charging of the electronic device's battery charging so long as the MagSafe device is connected to a power supply. The electronic device can be coupled by resting it on charging portion 120 and allowing magnets in the MagSafe device to attract the electronic device.

The first charging portion 120 may receive a MagSafe charging device by positioning the charging device in the removal access point 135. In this embodiment, the first charging portion 120 is positioned at an angle and allows for users resting their electronic devices better access to the screen of the device. The first charging portion 120 may manage one or more cables from the removal access point 135 by threading a cable through the opening 140 into the upper cavity 155. For users concerned with aesthetics, the charging apparatus allows for aesthetically pleasing cable management.

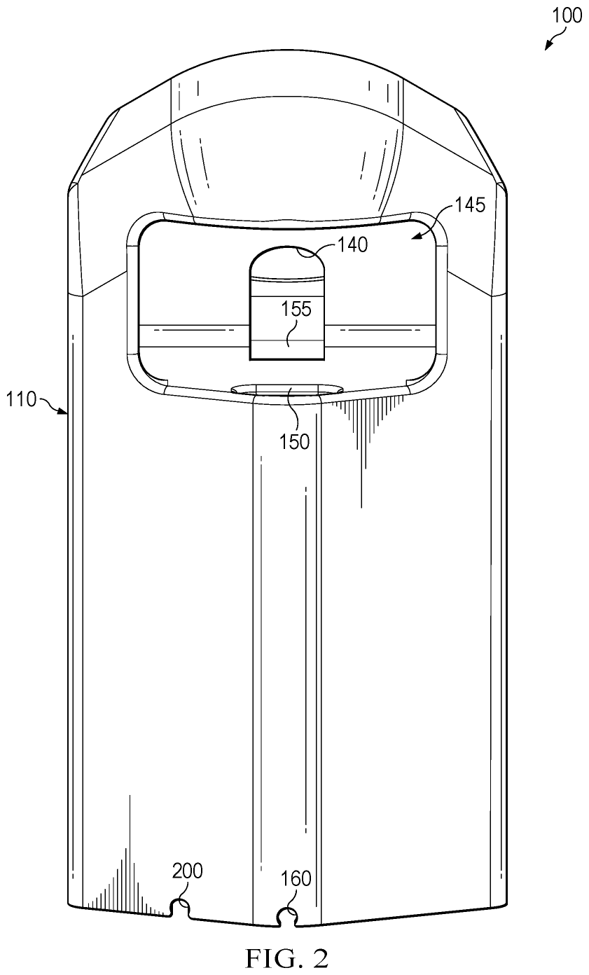

As best seen in FIG. 2, the window portion 145 allows a user access to the upper cavity 155 where they can manipulate cables to and from the opening 140 into and out of the upper cavity 155 that may then be threaded into or out of the cable slot 150.

As it is used herein, the word “side,” “surface,” or “portion” can mean a region or area along the perimeter of a rectangle, square, or other shape with straight sides, and can also mean a region or area along the perimeter of an oval, a circle, or other shape with curved or non-straight sides.

In some embodiments, the charging apparatus may include a second charging portion 190 configurable to receive an Apple Watch Magnetic Charger as shown, for example, in FIGS. 1, 4, and 8. An Apple Watch Magnetic Charger may be inserted into 190 with the charger's cables threaded through the secondary cable groove 200.

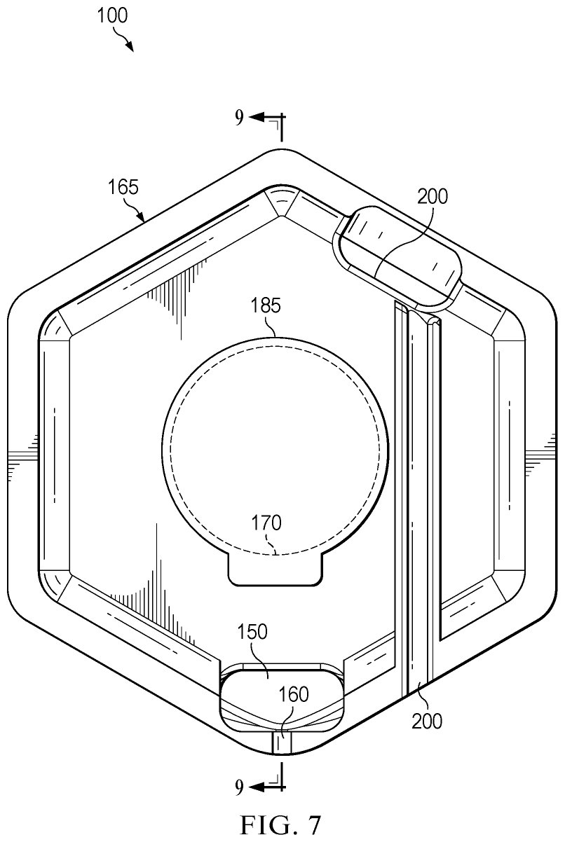

FIG. 7 is a bottom plan view of an embodiment of the charging apparatus 100. The base 165 of the charging apparatus contains an opening 170 configurable to receive a removable plug 185 (not shown). In this embodiment, the base 165 contains exactly one primary cable groove 160. In some embodiments, the base contains exactly one foot 205. A foot 205 is typically made of a soft material like rubber, felt, or silicone, and are attached to the base or underside of the charging apparatus. The purpose of the foot is to provide a cushioner layer and prevent the object from directly contacting or scratching the surface it is resting on. In other embodiments, the base contains a plurality of feet. Some embodiments have an adhesive layer on the bottom of the feet.

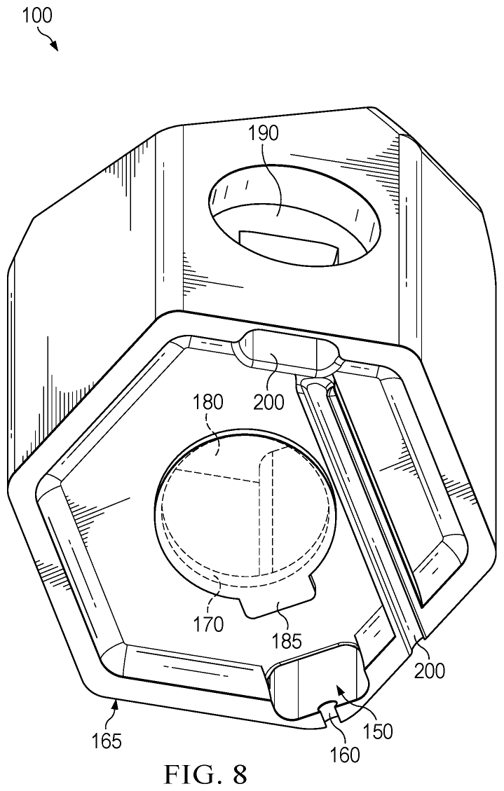

FIG. 8 is a bottom perspective view of the embodiment shown in FIG. 7. FIG. 8 more clearly depicts the base cavity 180. The opening 170 configured to receive a removeable plug (removeable plug not currently shown) allows a user to insert or remove weighs such as but not limited to steel bb shot. Objects like typical steel bb shot are dense and compact allowing for efficient weight distribution and the resulting augmentation of the charging device. Inserting more weightsthrough the opening 170 will increase the overall weight if the charging apparatus 100. In this respect, a user may take advantage of this feature and insert more weights order to increase the overall support that is given to a charging electronic device. Because the features and weights of different electronic devices varies widely, a user may configure his or her charger device to the weight specification that he or she prefers for their personal charging device. The device support primarily coming from the forces of the magnetic chargers. The weight of the base and overall resistance can be easily adjusted in order for a user to determine individual optimal one-handed manipulation and removal thereof a charging electronic device base. In some implementations, sufficient weight is provided that lifting the electronic device from the charging apparatus 100 will result in the electronic device decoupling from an installed MagSafe charger without significant movement of the charging apparatus 100. In some implementations, the total weight of the charging apparatus 100 is in the range of 300-1500 grams. In some implementations, the total weight of the charging apparatus 100 is greater.

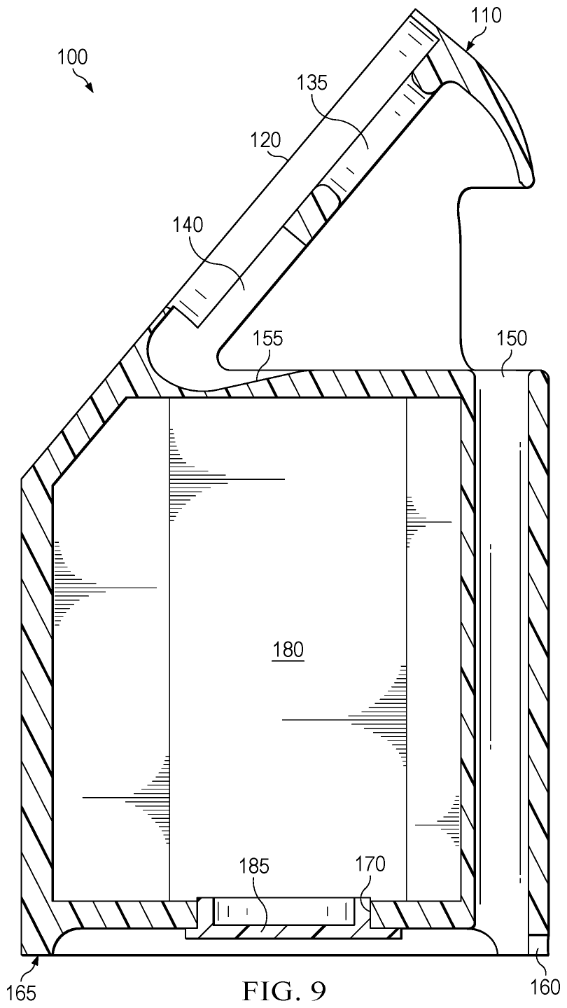

FIG. 9 is a cross-sectional view of an embodiment of the charging apparatus 100 depicted in FIG. 1. The the charging apparatus comprises a housing 110 and a charging portion 120. The charging portion 120 is configured to support the surface of an electronic device with the removal access hole 135 and contains an opening 140 into a upper cavity 155. In some embodiments, the cable slot 150 of the charging apparatus 100 contains a primary cable groove 160 that functions to position inserted cables in a way that reduces natural wear and tear, and the tends to promote better stability of the charging apparatus 100.

What is claimed is:

1. A charging apparatus, comprising:
a housing, comprising:
an upper cavity;
a first charging portion proximate to the upper cavity, the first charging portion containing a charging device hole configured to support the surface of an electronic device, wherein the first charging portion comprises:
a recessed charging tray; and
at least one opening configured to thread a cable into the upper cavity; and
a base comprising:
an opening to a base cavity, wherein the opening is configured to receive a removeable plug, the removable plug configured to receive an end of the cable, and
at least one stabilizing object.

2. The charging apparatus of claim 1, wherein the housing is made of a rubber composite.

3. The charging apparatus of claim 1, wherein the base is made of a rubber composite.

4. The charging apparatus of claim 1, wherein the recessed charging tray is configured to receive a MagSafe charging device.

5. The charging apparatus of claim 1, wherein the base comprises at least one foot.

6. The charging apparatus of claim 5, wherein the at least one foot comprises a rubber composite.

7. The charging apparatus of 6, wherein the at least one foot further comprises a surface adhesive.

8. The charging apparatus of claim 1, comprising the stabilizing object, wherein the stabilizing object comprises metal bb shot.

9. The charging apparatus of claim 1, wherein the charging apparatus is weighted to enable a user to remove the electronic device with one hand.

10. The charging apparatus of claim 9, wherein the charging apparatus is weighted to a total weight of at least 300 grams.

11. A method for adjusting the support of a electronic device comprising:
providing a charging apparatus, the charging apparatus comprising a releasably connectable plug that provides access to a cavity;
removing the releasably connectable plug;
inserting one or more weighted objects into the cavity; and
reinserting the releasably connectable plug.
